(19) United States
(12) Patent Application Publication
(10) Pub. No.: US 2020/0187687 A1
(43) Pub. Date: Jun. 18, 2020

(54) Multi-Layer Cushion With Convolute Sleeve

(71) Applicant: Tempur World, LLC, Lexington, KY (US)

(72) Inventors: Daniel Helms, Lexington, KY (US); Rachel Kuykendall, Lexington, KY (US); Anthony G. Turoso, Lexington, KY (US); Stephen Wallace, Lexington, KY (US)

(21) Appl. No.: 16/613,347

(22) PCT Filed: Aug. 13, 2018
(86) PCT No.: PCT/US2018/046466

§ 371 Date: Nov. 13, 2019

Related U.S. Application Data
(60) Provisional application No. 62/546,480, filed on Aug. 16, 2017.

(51) Int. Cl. A47G 9/10; B32B 27/06

(52) U.S. Cl. CPC A47G 9/1081; A47G 9/0253; A47G 2009/1018; B32B 27/065

(57) ABSTRACT

A multi-layer cushion with convolute sleeve comprises a cushion, such as a pillow, having an outer sleeve which has a first surface and a second surface which differ in structure. The first surface may be smooth and the second surface may comprise a plurality of convolute shapes defining a non-smooth surface. The outer sleeve may be reversible so that the smooth surface is facing out or the shaped surface is facing out. The first sleeve defines a cavity in which a plurality of chipped foam pieces may be positioned. The structure provides for two distinct feelings for the pillow, which a user may select.

### CLAIM TO PRIORITY

This PCT patent application claims priority to and benefit of, under 35 U.S.C. § 119(e), U.S. Provisional Patent Application Ser. No. 62/546,480, filed Aug. 16, 2017 and titled “Multi-Layer Cushion with Convolute Sleeve”, all of which is incorporated by reference herein.

### BACKGROUND

### Field of the Invention

Present embodiments relate to a cushion. More specifically, the present embodiments pertain to, without limitation, a cushion, for example a pillow, which is formed to provide different feel for the user depending on configuration.

### Description of the Related Art

The neck of a person lying in a supine or sidelying position is often out of alignment with the person's spine. This is commonly the case when the person's neck is supported by a pillow or multiple pillows such that the neck lies at an angle defined by the deflected height of the pillow(s), and this angle is typically not co-planar with the spine. The deflected height of the pillow is closely related to its stiffness, which is conventionally provided with filling material disposed within a fabric covering. Conventional filling material can include feathers, cotton, or a synthetic filler.

As is generally the case with support cushions and, in particular, with support cushions comprised of flexible foam or other body-conforming materials, the effectiveness of the support cushion in providing support to the body of a user is partly a function of how well the flexible foam responds to the contour of the particular user resting on the cushion.

Further, manufacturers prefer to have products which may satisfy a wide variety of users. Some users prefer a certain feel from a cushion while others may prefer an alternate feel. This is difficult to achieve but desirable so that the manufactured product appeals to a larger group of consumers.

The information included in this Background section of the specification, including any references cited herein and any description or discussion thereof, is included for technical reference purposes only and is not to be regarded subject matter by which the scope of the invention is to be bound.

### SUMMARY

The present embodiments provide one or more of the features recited in the appended claims and/or the following features which alone or in any combination, may comprise patentable subject matter.

The multi-layer cushion with convolute sleeve comprises a cushion, for non-limiting example a pillow, having an outer sleeve which has a first surface and a second surface which differ in structure. The outer sleeve comprises a first surface which is smooth and the second surface comprises a plurality of convolute shapes defining a non-smooth surface. The outer sleeve may be reversible so that the smooth surface is facing out or the shaped surface is facing out. The first sleeve defines a cavity in which a plurality of chipped foam pieces may be positioned. The structure provides for two distinct feelings for the pillow, which a user may select.

According to some embodiments, a cushion comprises a visco-elastic first sleeve having a first surface and a second surface, wherein one of the first and second surfaces is a substantially smooth surface and the other of the first and second surfaces comprises a plurality of convolute shapes. A cavity is defined by a closed perimeter of the first sleeve, and a plurality of pieces of visco-elastic chipped foam are disposed within said cavity.

Optionally, any of the following embodiments may be utilized alone or in any combination. The cushion may be a pillow. An outer surface of the sleeve may be the smooth surface and an inner surface of the sleeve may comprise the plurality of convolute shapes. The visco-elastic chipped foam may be disposed directly in the cavity. In other embodiments, the cushion may further comprise a second sleeve wherein the visco-elastic chipped foam is positioned. The cushion may further comprise the second sleeve with the visco-elastic chipped foam disposed in the cavity. The outer surface of the sleeve may comprise the plurality of convolute shapes and the inner surface may be the smooth surface. The visco-elastic chipped foam is disposed directly in the cavity. The cushion may further comprise a second sleeve wherein the visco-elastic chipped foam is positioned. The cushion may further comprise the second sleeve with the visco-elastic chipped foam disposed in the cavity. The cushion may comprise a first sleeve defined by one or more pieces of visco-elastic foam. The cushion may be a pillow and may further comprise a neck bolster.

According to a second embodiment, a cushion comprises a visco-elastic first sleeve having an inner surface and an outer surface, wherein one of said inner and outer surfaces is a substantially smooth surface and the other of the inner and outer surfaces comprises a plurality of convolute shapes, a cavity defined by a first sleeve, the cavity having an opening to access the cavity and a closure to allow opening and closing of the first sleeve.

Optionally, the visco-elastic first sleeve may be reversible to position the smooth surface outwardly in one configuration to provide a first feeling and the plurality of convolute shapes outwardly in a second configuration to provide a second feeling, a plurality of visco-elastic chipped foam pieces disposed within the cavity.

According to a further embodiment, a cushion comprises a visco-elastic sleeve defined by a first layer of visco-elastic material and a second layer of visco-elastic material, the first layer and the second layer being joined about a periphery to define a cavity, chipped foam disposed within the cavity of the sleeve, the first layer having an outer surface with a plurality of convolute shapes, the second layer having a smooth outer surface.

Optionally, the first layer and the second layer may be the same thickness. The first layer and the second layer may alternately be of differing thicknesses. The second layer may be of a larger thickness dimension than the first layer. The second layer may have a smooth outer surface.

All of the above outlined features are to be understood as exemplary only and many more features and objectives of the assembly for and method of manufacture of multi-layer foam laminate mattresses may be gleaned from the disclosure herein. Therefore, no limiting interpretation of this summary is to be understood without further reading of the entire specification, claims and drawings, included herewith.

### BRIEF DESCRIPTION OF THE DRAWINGS

In order that the embodiments may be better understood, the multi-layer foam cushion with convolute sleeve will now be described by way of examples. These embodiments are not to limit the scope of the claims as other embodiments of the multi-layer foam cushion will become apparent to one having ordinary skill in the art upon reading the instant description. Non-limiting examples of the present embodiments are shown in figures wherein:

FIG. 1 is a perspective view of a first cushion shape, illustratively embodied as a pillow;

FIG. 2 is a perspective view of an alternate cushion shape;

FIG. 3 is a section view of an embodiment of a cushion;

FIG. 4 is a section view of a second embodiment of a cushion;

FIG. 5 is a partially exploded section view depicting a cover which may be added to the cushion; and,

FIG. 6 is a section view of a further alternative embodiment.

### DETAILED DESCRIPTION

It is to be understood that the multi-layer cushion with convolute sleeve is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The embodiments are being practiced or of being carried out in various ways.

Also, it is to be understood that phraseology and terminology used herein with reference to device or element orientation (such as, for example, terms like “front”, “back”, “up”, “down”, “top”, “bottom”, and the like) are only used to simplify description of the present embodiments, and do not alone indicate or imply that the device or element referred to must have a particular orientation. In addition, terms such as “first”, “second”, and “third” are used herein and in the appended claims for purposes of description and are not intended to indicate or imply relative importance or significance.

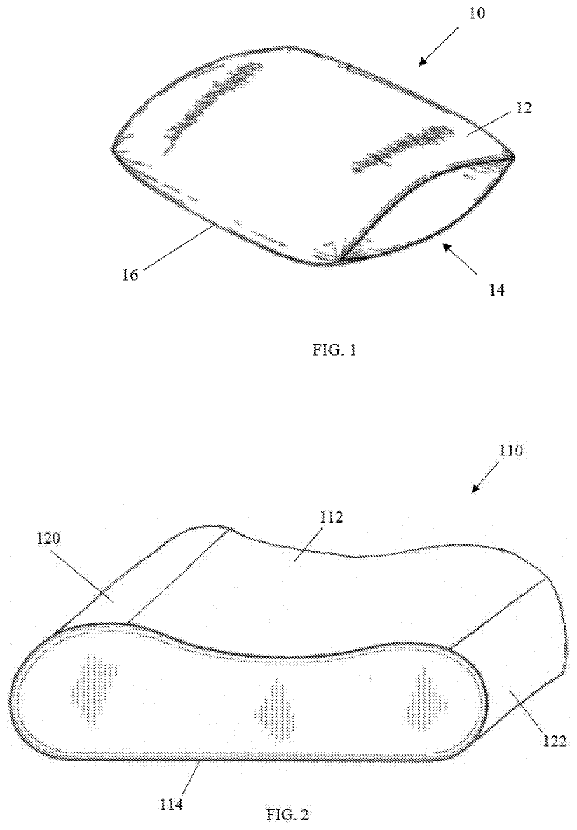

Referring now in detail to the drawings, wherein like numerals indicate like elements throughout several views, there are shown in FIGS. 1-6 various embodiments of a multi-layer cushion with convolute sleeve are shown and provided.

Referring now to FIG. 1, a perspective view of a cushion 10 is shown having an upper side 12 and lower side 14 and defined by at least one perimeter edge 16. The instant cushion 10 is shown embodied according to some illustrative, non-limiting embodiments as a pillow. The cushion 10 may have various shapes and, according to the instant embodiment, has a generally rectangular upper and lower surface, although other shapes may be used, for example circular, square or other geometric, regular or irregular, shapes. By way of example only, and without limitation, the cushion 10 and any embodiments thereof, may be generally wedge-shaped, can have a concave or convex cross-sectional shape, can have a combination of convex and concave shapes, can have a stepped, faceted, or other shape, can have a complex or irregular shape, and/or can have any other shape desired. Further, it will be appreciated that the cushion 10 can have various other desired shapes including, without limitation, those that are round, oval, rod, crescent, U-shaped, Y-shaped, L-shaped, star, irregular, and the like. Any of these or other such shapes may, for example, be associated with pillows or cushions. The surface shape of the cushion 10 may be planar or may be curved, as shown.

The term cushion may comprise, for non-limiting example, various types of supports including bedding and/or cushions for chairs and furniture, pillows, padding for medical devices and equipment (e.g., wheelchair seat pads, wheelchair padding, medical pads, hospital gurney pads, operating table pads, positioning pads), padding for furniture (e.g., upholstery padding, furniture cushions, furniture pads), padding for athletic equipment and devices (e.g., athletic cushions, sports and athletic padding, gymnastic mats), padding for recreational equipment and devices (e.g., camping and sleeping mats), padding for apparel (e.g., bra straps, shoulder pads, shoe linings, boot linings), padding for household goods (e.g., anti-fatigue mats, mattress pads, mattress covers, mattress “toppers,” the pillow-top portion of pillow-top mattresses, pillows, and the like); padding accessories (e.g., briefcase shoulder straps, computer carrying cases, purses, gloves, and the like), pet beds, and the like. Thus any of these types of structures, and others, may fall within the scope of the term cushion.

With reference now to FIG. 2, a further embodiment of a cushion 110 is provided. In this embodiment, the cushion 110 is shown as a pillow and includes an upper side 112 and a lower side 114. In this embodiment, in addition to the difference in shape, the upper side 112 and the lower side 114 are different in form. The first side 112 includes a first neck bolster 120 and a second neck bolster 122, which are of different radiuses. Thus the cushion 110 may be more functional to people of different sizes and sleeping positions. In the instant embodiment, the surface of upper side 112 is curvilinear and the lower side 114 is generally flat. However, the upper and lower sides may be formed in the same manner in other embodiments.

As with the first embodiment, the instant embodiment 110 may be embodied variously in ways other than a pillow, as described previously. For example, cushions for furniture or mattresses, or any type of body support, may utilize the arrangement described herein.

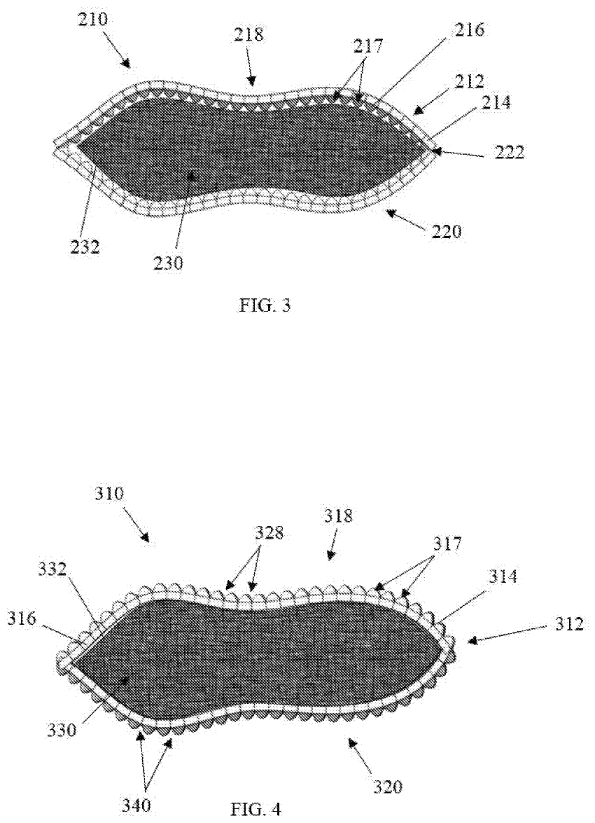

Referring now to FIG. 3, a section view of a cushion 210 is shown. The cushion 210 may be representative of any of the shapes used in FIGS. 1 and 2, or various other cushion types/shapes as described. Further, while cushion 210 is embodied as a pillow, other types of cushions may utilize the depicted structures. The cushion 210 may include a first sleeve 212 formed at least one layer of visco-elastic foam, or substrates. Where a single piece of foam is used, the material is rolled over on itself and mechanically joined, bonded or otherwise adhered. Alternatively, multiple pieces of visco-elastic foam, or laminates thereof, may be used to form the shape of the cushion 210. The multiple pieces of visco-elastic foam may be joined about a perimeter in a variety of ways, such as by thread, adhesive, heat, combinations thereof or other mechanical joining, or other bonding methods and/or structures. The visco-elastic foam aids to distribute pressure or force across the surface of the cushion and reduce pressure points. Additionally, the foam sleeve 212 may comprise of one or more layers.

The cushion 210, according to some embodiments, comprises the first sleeve 212 having two layers of visco-elastic foam (“memory foam”), each layer having a first surface 214 and a second surface 216. The sleeve 212 may be formed of various shapes and therefore the first sleeve 212 may comprise various shapes. In the illustrative example, the sleeve 212 includes a first layer 218 of visco-elastic foam and a second layer 220 of visco-elastic foam. Each layer 218, 220 has the first surface 214 and a second surface 216. The first sleeve 212 may be reticulated visco-elastic foam, non-reticulated visco-elastic foam or some combination thereof. Further each layer 218, 220 may be a single layer or two or more sub-layers, which are laminated.

In the instant embodiment, the first sleeve 212 is formed by joining one or more layers of visco-elastic foam together about a periphery. With all but one of the periphery edges closed, a cavity 222 is created within the first sleeve 212 which is accessible. Within the cavity 222, a plurality of chipped foam 230 pieces may be disposed.

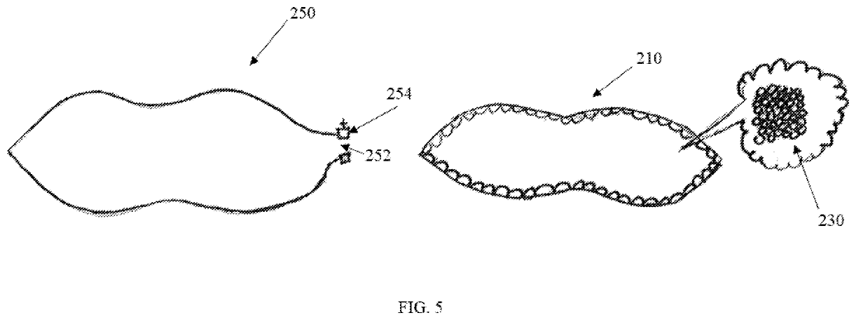

The illustrative cushion 210 may be formed in two ways. In a first embodiment depicted, the first, outer surface of the sleeve 212 is a smooth surface. In the embodiment depicted in FIG. 4, the sleeve 312 orientation is reversed so that the second, inner surface is facing outward.

Referring to the instant embodiment, the first surface 214 is smooth while the second surface 216 has a convolute finish or shape. The convolute shapes may be of an egg-crate foam shape in some embodiments. In other embodiments, the shape of the convolute surface may be of alternate shapes, such as for non-limiting example, engineered shapes, or any geometric other form which creates a cavity such as ridges, ripples, waves, pyramids, etc. or any regular or irregular shapes which provide pressure relief or support may also be envisioned.

With the convolute surface 216 facing inward, the convolute surface 216 can mitigate the feeling of lumps which may otherwise occur and be felt. This is an unexpected result of the pieces of chipped foam 230 filling spaces between peaks or valleys of the convolute surface 216.

In some embodiments two or more pieces of visco-elastic foam may be joined to form the first sleeve 212. As shown in FIG. 3, two pieces 218, 220 are used to define the sleeve 212 and cavity 222 therein. In some other embodiments, a single piece of foam may be folded over on itself and sealed around the periphery to form the first sleeve 212 and the cavity 222. This single foam embodiment may also be defined by a single layer or two more laminate sub-layers.

The cavity 222 provides a space for a plurality of chipped or chopped visco-elastic foam 230. The chipped foam 230 may be formed of various sizes and/or shapes. The chipped foam 230 may be placed directly into the cavity 222 of the first sleeve 212 in some embodiments. In other embodiments, the chipped foam 230 may be inserted into a second sleeve 232 and the sleeve 232 including the chipped foam 230 may be inserted into the cavity 222 of the first sleeve 212.

The chipped foam 230 forms a filler material for the sleeve 212. The chipped foam 230 may be formed of visco-elastic foam which is chipped, chopped, shredded, torn, or otherwise formed in small pieces. For example, the chipped visco-elastic foam 230 may be in a granulated form. Moreover, the pieces of chipped foam 230 may be the same shape or may be differing in shape. Further, the chipped foam 230 may be the same size, or of differing size, or may be within one or more ranges of sizes.

The chipped foam 230 may be non-reticulated foam. However, in other embodiments, the visco-elastic foam 230 of the filler material may be or may include reticulated visco-elastic foam. The cells of reticulated foam are essentially skeletal structures in which many (if not substantially all) of the cell walls separating one cell from another do not exist. In other words, the cells are defined by a plurality of supports or “windows”, and by no cell walls, substantially no cell walls, or by a substantially reduced number of cell walls. A foam can be considered “reticulated” if at least 50% of the walls defining the cells of the foam do not exist (i.e., have been removed or were never allowed to form during the manufacturing process of the foam). The granulated visco-elastic chipped foam 230 filler material can be 100% reticulated visco-elastic foam, 100% non-reticulated visco-elastic foam, or can include any relative amounts of reticulated and non-reticulated visco-elastic foams desired.

According to some embodiments, the visco-elastic chipped foam 230 may have a density of about 85 kg/m³. However, a suitable density for the visco-elastic chipped foam 230 for an average weight cushion, for example, can be between about 30 and about 140 kg/m³. Further, a suitable density for the visco-elastic chipped foam 230 for a light-weight pillow, for example, can be less than about 40 kg/m³. Likewise, a suitable density for the visco-elastic chipped foam 230 for a heavy-weight cushion, for example, can be greater than about 130 kg/m³. Alternatively, the granulated viso-elastic chipped foam 230 utilized as the filler material can have any density in accordance with the desired characteristics of the cushion. In addition, a suitable visco-elastic chipped foam 230 possesses an indentation load deflection, or “ILD,” of 65% between 100-500 N loading, and a maximum 10% rebound according to the test procedure governed by the ASTM-D-1564 standard.

In some embodiments, the chipped foam 230 may include granulated highly-elastic (“HE”) foam in addition to granulated visco-elastic foam. The HE foam can take any of the granulated forms described above with reference to the granulated or chipped visco-elastic foam 230.

In still other embodiments, the chipped foam may be formed of other types of foam. For example, other types of chipped foam may include but is not limited to, conventional foam, latex foam, polystyrene beads, feather, down and the like. These may be used exclusively, in combination with each other or one or more may be used in combination with the visco-elastic chipped foam. This list is not exhaustive and should not be considered limiting, therefore other materials may be utilized.

The chipped foam 230, whether or not HE foam, can be made up of recycled, virgin, or scrap visco-elastic material. As will be appreciated by one of ordinary skill in the art, the granulated chipped foam 230 can be produced in any manner desired, including without limitation by shredding, cutting, grinding, chopping, tearing, or ripping virgin, recycled, or scrap visco-elastic material, by molding or casting individual pieces, or in any other suitable manner. The chipped visco-elastic foam 230 may consist of pieces of a nominal length, or the chipped visco-elastic foam 230 may consist of pieces of varying length. For example, chipped visco-elastic foam 230 may have a nominal length of about 1.3 cm. Also, chipped visco-elastic foam 230 may consist of varying lengths between about 0.6 cm and about 2 cm. The chipped visco-elastic foam 230 can be as short at 0.3 cm and as long as 4 cm, or the chipped visco-elastic material 230 can be any length in accordance with the desired characteristics of the cushion 210. In some embodiments, the chipped visco-elastic foam 230 is comprised of 16-20% having a length longer than 2 cm, 38-42% having a length between 1 and 2 cm, and 38-42% of the pieces shorter than 1 cm. Significant cost savings and waste reduction can be realized by using scrap or recycled visco-elastic chipped foam 230 rather than virgin filler material. Chipped visco-elastic foam 230 can be made from a polyurethane foam material, however, the chipped foam 230 can also be made from any other visco-elastic polymer material that exhibits similar thermally-responsive properties.

As shown in this instant embodiment, the first sleeve 212 includes the second inner surface 216 which has a plurality of convolute shapes 217 extending inwardly relative to the cavity 222. The convolute shapes 217 are non-planar and allow for the fitting or engagement of the chipped foam 230 to position within the valleys of convolute shapes 217. As a result, the combination of the smooth outer surface 214 and the displacement of the chipped foam 230 within the convolute shapes 217 of the first sleeve 212 reduce or mitigate a lumpy feeling that the user may otherwise feel.

According to a second embodiment, a cushion 310, such as a pillow, is shown. The cushion 310 is similar to cushion 210 in that the cushion 310 has a first sleeve 312. The first sleeve 312 is defined by a first outer surface 314, which has a plurality of convolute shapes 317 and a second inner surface 316. In this embodiment, the sleeve 312 is again formed of visco-elastic material but in this embodiment, the inner and outer surfaces 314, 316 are reversed relative to the cushion 310.

According to the instant embodiment, the convolute shapes 317 are extending outwardly from the sleeve 312. As a result, the smoother inner surface 316 is directed inwardly. In this embodiment, with the smoother surface 316 inward, the user has a different feeling when using the cushion 310.

Within the first sleeve 312 is a cavity 322, which receives chipped foam 330. The foam 330 may be visco-elastic foam which is chipped, chopped, torn, or the like to form small pieces. The chipped foam 330 is positioned within the cavity 322 and may be placed therein in either of two manners. In some embodiments, the chipped foam 330 may be placed in the cavity 322 directly. In some other embodiments, the chipped foam 330 may be placed in a second sleeve 332 which is placed in the first sleeve 312.

The user may feel these plurality of shapes more readily than in the prior embodiment. Whereas the previous embodiment mitigates the lumpy feeling of the chipped foam 230, the instant embodiment provides more of a lumpy feeling in addition to the feeling of the convolute shapes 317 of the first surface 314.

With regard to the preceding embodiments, the first sleeve 212, 312 is formed of a visco-elastic foam, which for example may be open-celled non-reticulated visco-elastic foam (sometimes referred to as “memory foam” or “low resilience foam”). This may include the one or more pieces of material defining the sleeves 212, 312. The one or more pieces may be bonded together, at periphery of the sleeves 212, 312 by mechanical structures, by adhesive or cohesive bonding material, by tape, hook and loop fastener material, conventional fasteners, stitches extending at least partially through the top and bottom layers 218, 220 or in any other suitable manner. Each of the layers 218, 220, or the cushions 210, 310 as a whole, may have a sidewall defining a thickness of the cushion as a whole or the thickness may be defined by the manner in which ends of the cushion are joined. Moreover, each of the layers 218, 220 may be defined by one or more layers of foam.

In some embodiments, the visco-elastic foam sleeve 212 may also be reticulated foam. The foam sleeve 212 may comprise a cellular structure of flexible visco-elastic polyurethane foam in which the walls of the individual cells are substantially intact. In some embodiments, the foam sleeve 212 may comprise reticulated foam wherein the cells of the foam of the sleeve 212 are skeletal structures in which many (if not substantially all) of the cell walls separating one cell from another do not exist. In other words, the cells are defined by a plurality of supports or “windows” and by no cell walls, substantially no cell walls, or by a substantially reduced number of cell walls. In some embodiments, a foam is considered “reticulated” if at least 50% of the walls defining the cells of the foam do not exist (i.e., have been removed or were never allowed to form during the manufacturing process of the foam).

The plurality of convolute shapes 217 may comprise various structures. For example, as an alternative to, or in addition to the egg-crate shape, the convolute shapes may be defined by ribs, bumps, and other protrusions of any shape and size, surfaces having grooves, dimples, and other apertures that form the surface of the visco-elastic layers 218, 220.

Forming the first sleeves 212, 312 of visco-elastic foam provides a relatively soft and comfortable surface for a user. The visco-elastic foam of the sleeves 212, 312 and/or the chipped foam 230, 330 can possess specific thermally responsive properties which cause the cushion 210 to conform to the shape of the portion of a person's body that contacts the cushion. The visco-elastic foam sleeve 212 and chipped foam 230 can have a lower stiffness or hardness at an elevated temperature as compared to the stiffness at a cooler temperature. The body heat of the person acts to soften the portion of the cushion 210, 310 in contact with the body, while the portion of the cushion 210, 310 not contacting the body remains more firm. As a result, the cushion 210, 310 illustrated in FIGS. 3-4 can allow for greater comfort over a conventional pillow by accommodating each user's body form. The nature of visco-elastic foam along with the slow recovery characteristic provides that the cushion can also conform to a user's body, thereby distributing the force applied by the user's body. According to some embodiments, visco-elastic material defining the first sleeves 212, 312 may have a hardness of at least about 30 N and no greater than about 175 N for desirable softness and body-conforming qualities. In other embodiments, the visco-elastic material defining the sleeves 212, 312 may have a hardness of at least about 40 N and no greater than about 110 N is utilized for this purpose. In still other embodiments, a top layer 218 having a hardness of at least about 40 N and no greater than about 75 N is utilized. Unless otherwise specified, the hardness of a material referred to herein is measured by exerting pressure from a plate against a sample of the material having length and width dimensions of 40 cm each (defining a surface area of the sample of material), and a thickness of 5 cm to a compression of 40% of an original thickness of the material at approximately room temperature (e.g., 21-23 Degrees Celsius), wherein the 40% compression is held for a set period of time, following the International Organization of Standardization (ISO) 2439 hardness measuring standard.

The sleeves 212, 312 can also have a density providing a relatively high degree of material durability. The density of the foam in the sleeves 212, 312 can also impact other characteristics of the foam, such as the manner in which the sleeves 212, 312 respond to pressure, and the feel of the foam. In some embodiments, the sleeves 212, 312 may have a density of no less than about 30 kg/m³ and no greater than about 150 kg/m³. In other embodiments, the sleeves 212, 312 having a density of at least about 40 kg/m³ and no greater than about 125 kg/m³ is utilized. In still other embodiments, the sleeves 212, 312 having a density of at least about 60 kg/m³ and no greater than about 115 kg/m³ is utilized.

Further, the foam defining sleeves 212, 312 may have the same characteristics for density and hardness as the chipped foam 230, 330, according to some embodiments. However, in other embodiments, the foam of sleeves 212, 312 may have differing hardness and density in order to provide desirable characteristics. Additionally, other characteristics which may be considered include, but are not limited to, pressure relief, conformance, support, heat flow, and air permeability.

The visco-elastic foam of the sleeves 212, 312 can be selected for responsiveness to any range of temperatures. However, in some embodiments, a temperature responsiveness in a range of a user's body temperatures (or in a range of temperatures to which the mattress 102 is exposed by contact or proximity to a user's body resting thereon) can provide significant advantages. For example, a visco-elastic foam selected for the top layer 218 can be responsive to temperature changes above at least about 0° C. In some embodiments, the visco-elastic foam forming the sleeves 212, 312, and 230, 330 can be responsive to temperature changes within a range of at least about 10° C. In other embodiments, the visco-elastic foam selected for the top layer 110 can be responsive to temperature changes within a range of at least about 15° C.

As used herein and in the appended claims, a material is considered “responsive” to temperature changes if the material exhibits a change in hardness of at least 10% measured by ISO Standard 3386 through the range of temperatures between 10 and 30 degrees Celsius.

Further, where the sleeves 212, 312 are formed of pieces of visco-elastic foam, for example 218, 220 which are joined together, the layers 218, 220, 318, 320 may be formed of visco-elastic foams with the same or alternatively differing characteristics of hardness, density or other such characteristics. Further, as noted earlier, each layer may be a single layer or two or more sub-layers.

In some embodiments, the two or more layers of material may be joined to form the sleeve 212, 312. That is, two layers of materials may define each of the layers 218, 220 and 318, 320 which form the sleeves 212, 312. The layers may be joined together to provide the differing inner and outer surfaces. The layers may be affixed by any suitable means known in the art. Layers of the inner and outer surfaces 214, 216 and the layers defining each of surfaces 314, 316 may be joined by spray-on adhesive, injection molded, extruded, coextruded, laminated, and the like. In several embodiments, layers may be stapled, tacked, welded, laminated, mechanically affixed via friction or interference fit, adhered via an adhesive, a glue, a cement, or other material with adhesive properties, stitched, affixed via hook and loop fastener, a zipper, a Dennison-style tag, snaps, and/or other reversible means, and combinations thereof. For purposes of present embodiments, various layers or the sub-layers may be joined with adhesives including glues, cements and other materials with adhesive properties. However, in other embodiments, a single layer with differing surfaces may form each of the layers 218, 220, 318 and 320.

In some embodiments, where adhesive is used to join either the layers 218, 220 or sub-layers which define each of the layers 218, 220 or 318, 320, various adhesives may be used. In some embodiments, an adhesive may be located at interfaces between the layers 218, 220, for example about the periphery of the cushion 10, 110, 210, 310. Adhesives that may be used in the present disclosure include any of various adherent materials or fasteners. Specific examples of adhesives include, but are not limited to, hot melt, water-based, and pressure-sensitive adhesives, fire-resistant adhesives, and mixtures thereof. Further, a layer and/or an adhesive may further include a silica, a metallic layer, a plastic, such as an acrylic, a modacrylic, a polyolefin, a latex, a polyurethane, and combinations and/or blends thereof. In addition, a layer may further include biocides, preservatives, odor blocking agents, scents, pigments, dyes, stain guards, antistatic agents, anti-soiling agents, water-proofing agents, moisture wicking agents, and the like, as are known in the art.

The layers 218, 220 may be of any thickness. For example, in several preferred embodiments, the component layer is less than or about ½ inch, less than or about 1 inch, less than or about 2 inches, less than or about 3 inches, less than or about 4 inches, less than or about 5 inches, less than or about 6 inches, less than or about 8 inches, or less than or about 12 inches, and all thicknesses in between. Component layers may also be of varying widths and lengths that are not necessarily tied to the size of the component. For example, a mattress may include a first layer with a first width and a second layer with a second width, where the first width is wider or narrower than the second width. When a layer is wider than the component, it may be folded in upon itself or folded upwardly or downwardly along the side of the component to form a portion of a sidewall of the component. Similar variability with respect to layer length is also possible.

With reference still to FIGS. 3 and 4, the inner surfaces 216, 316 and outer surfaces 214, 314 may be of the same or differing thicknesses. In some embodiments, for example, the smooth surfaces 214, 316 may be thicker than the convolute surface 217, 317. This may be used with either embodiment, but may be desirable where the convolute surface 217 is disposed toward the interior of the pillow or cushion. In some non-limiting embodiments for example, the smooth surface 214, 316 may be between about 2 and 8 cm and in some other embodiments, the smooth surface or layer 214, 316 may be about 4 cm. Other thicknesses may be utilized and this is merely one embodiment.

With reference briefly to FIG. 5, the cushions 10, 110, 210, 310 may further comprise a cover 250 formed of any one or more of the following: a fabric, a natural fiber, a synthetic fiber, a ticking layer, a quilt layer, a thread layer, a film, a foam, a gel, a gel foam, a multi-gel foam, a high thermal conductivity foam, a woven layer, a nonwoven layer, a fire-resistant layer, a non-skid layer, and/or combinations thereof. The cover 250 may encase the cushion 210 and may contour to the shape of the cushion. The cover 250 may be permanently affixed or may be removable and washable. In some embodiments, the removable cover 250 may have a resealable slot through which the cushion 210 may be inserted or removed. The slot 252 extends across an edge portion of the cushion and may be opened and closed by a closure 254, for non-limiting example, a zipper or hook and loop. It should be clear to one skilled in the art that cover 250 may be used in any of the embodiments of cushions 10, 110, 210, 310.

The cover 250 may also be formed of foams which are also convolute and allow for breathing passages to improve air flow and provide improve heat control. The cover 250 may comprise one or more layers of cover materials or cover internal layers which may include foam, fibers, cotton, wool, feathers or any other synthetic or natural materials in a generally co-planar arrangement as shown. The cover 250 may also include, be made of or treated with a flame resistant or fire retardant material. The cover 250 may thus serve as a flame resistant barrier which will withstand a standardized flame burn test for cushions over the entire surface area of the cushions 10, 110, 210, 310. The fire resistant material for cover 250 may include flame and heat resistant materials such as fiber mats, woven or nonwoven fabrics, knitted fabrics, films, laminates, and flexible composites or combinations thereof. Fibers of cover 250 can be formed into a batt or fabric web and stitch-bonded using the appropriate yarn to form a fire resistant layer. Flame and heat-resistant fibers known in the art include, but are not limited to, boron, basalt, carbon, glass, ceramic, graphite, aramid polymers, polytetrafluoroethylene (PTFE), polyimide, phenolformaldehyde, polybis-imidazole, polyvinylidene chloride, polysulfide, melamine, silicon carbide, and blends thereof.

Further, in embodiments, where a cover is not utilized, one skilled in the art should realize that the fire-resistant fibers may be used within the visco-elastic foam sleeves described herein in a manner to provide fire resistance.

With reference again to FIGS. 3 and 4, the non-planar shape of the surfaces 216, 314 may be formed of various shapes. The plurality of shapes 217, 317 can take any of the forms described above and can be defined by a plurality of protrusions and/or a plurality of valleys or depressions 328, as also described above. In the depicted embodiments, the shapes 217, 317 are generally hemispherical. Between the peaks of the hemispheres are valleys. These may be rounded as well. However, other geometries can be used such as curved, linear, curvilinear, regular or irregular shapes and the like.

The passages 340 between the shapes 317 of the reticulated visco-elastic foam sleeve 312 can also provide a degree of ventilation and/or enhanced heat dissipation for the cushion 310. These passages 340 can be particularly useful in reducing heat in regions of the cushion 310 where a user's head is located. These passages 340 can also supplement the ability of the cushion 310 to dissipate heat along a lower surface of the cushion 310.

Still further, any of the layers of any of the preceding embodiments may be formed of a polymeric gel. One exemplary composite material can comprise a polymeric gel material that at least partially penetrates an open-cell foam material. For ease of illustration, the present composite materials may be referred to hereinafter as “gel-infused materials” or “gel-infused composite materials,” but it should be understood that the disclosure is not limited to any particular type of material. “Composite material,” as used herein, means a first material that at least partially penetrates a second material; the first and second material can be the same or different materials.

Further, in some embodiments, the sleeve 212, 312 may be reversible. A closure may be used to allow removal of the chipped foam. The sleeve 212, 312 may be reversed, then the chipped foam reinserted and the closure closed.

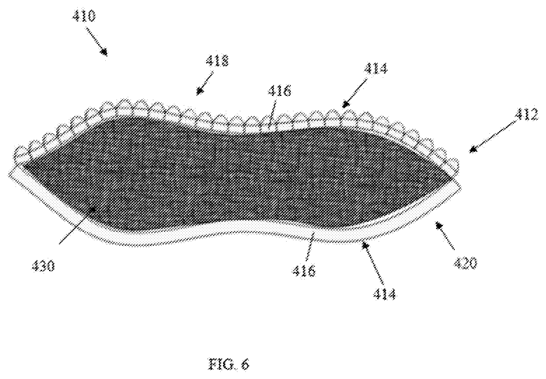

With further reference now to FIG. 6, an additional embodiment is provided which may utilize, in whole or part, any of the previously described embodiments or characteristics. In the instant embodiment, a cushion 410 is embodied as a pillow for non-limiting example. The instant embodiment provides a sleeve 412 having two layers of visco-elastic foam (“memory foam”), each layer having a first surface 414 and a second surface 420. The sleeve 412 may be formed of various shapes and therefore the first sleeve 412 may comprise any of various shapes and may be a pillow, mattress or other types of support cushions. In the illustrative example, the sleeve 412 includes a first layer 418 of visco-elastic foam and a second layer 420 of visco-elastic foam which are joined along a periphery. Each layer 418, 420 has the first surface 414 and the second surface 416, and as in previous embodiments, may be smooth or convolute. The first sleeve 412 may be reticulated visco-elastic foam, non-reticulated visco-elastic foam or some combination thereof. Further each layer 418, 420 may be a single layer or two or more sub-layers, which are laminated, sewn, glued or otherwise joined.

In the instant embodiment, the layer 418 may provide one feel for the user on one side of the cushion 410 and the second layer 420 may provide a second feel for the user on a second side of the cushion 410. For example, the instant cushion 410 may provide a convolute outer surface 418 which provides a desirable feel on the outside surface for some people. While the lower layer 420 may be smooth to provide a feel which may be desirable to some other people. Thus, rather than a consistent outer surface about the entire cushion, the instant embodiment may provide a first surface feel and a second surface feel, differing from the first surface feel on the second side of the pillow.

The instant embodiment may also have layers 418, 420 of same of differing thicknesses. For example, in the instant embodiment, the convolute layer 414 may be of a thinner dimension and the lower layer 420 may have a thicker dimension. The convolute layer 414 may have a thickness of, for example, 1-4 cm while the smooth layer 420 may be thicker having an illustrative dimensional range of 2-8 cm. In other embodiments, the convolute layer 414 may be thicker than the smooth layer 420.

In any of the previously described, the periphery of the layers 418, 420 are joined together to form the sleeve 412. The sleeve 412 is filled with chipped foam 430 before the last edge is closed. The sleeve 412 may be permanently closed or a closure may be used to close the sleeve 412. The convolute shapes may be any of various shapes as described earlier and may be consistent in size and/or shape or may vary along the outer surface of layer 420. Additionally, the chipped foam 430 may be placed directly in the sleeve 412 or may optionally be placed within a second sleeve, such as sleeves 232, 332 (FIGS. 3 and 4), which is placed within the sleeve 412.

Any of the previously described foams may be utilized for the layers 418, 420. Likewise, any of the previously described types of chipped foams may be used for the chipped foam 430.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teaching(s) is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

What is claimed is:

1. A cushion comprising:
a visco-elastic first sleeve having a first surface and a second surface, wherein one of said first surface or said second surface is a substantially smooth surface and the other of said first and second surfaces comprises a plurality of convolute shapes;
a cavity defined by a closed perimeter of said first sleeve;
a plurality of pieces of visco-elastic chipped foam disposed within said cavity.

2. The cushion of claim 1, wherein said cushion is a pillow.

3. The cushion of claim 2 wherein one of said first and second surfaces is an outer surface of said sleeve that is said smooth surface and the other of said first and second surfaces is an inner surface of said sleeve that comprises said plurality of convolute shapes.

4. The cushion of claim 3, wherein said visco-elastic chipped foam is disposed directly in said cavity.

5. The cushion of claim 3, further comprising a second sleeve wherein said visco-elastic chipped foam is positioned.

6. The cushion of claim 5, further comprising said second sleeve with said visco-elastic chipped foam is disposed in said cavity.

7. The cushion of claim 2 wherein one of said first and second surfaces is an outer surface of said first sleeve that comprises said plurality of convolute shapes and the other of said first and second surfaces is said inner surface having said smooth surface.

8. The cushion of claim 7, wherein said visco-elastic chipped foam is disposed directly in said cavity.

9. The cushion of claim 7 further comprising a second sleeve wherein said visco-elastic chipped foam is positioned.

10. The cushion of claim 9 further comprising said second sleeve with said visco-elastic chipped foam is disposed in said cavity.

11. The cushion of claim 2, said first sleeve defined by one or more pieces of visco-elastic foam.

12. The cushion of claim 2, wherein said pillow further comprises a neck bolster.

13. A cushion, comprising:
a visco-elastic first sleeve having an inner surface and an outer surface, wherein one of said inner and outer surfaces is a substantially smooth surface and the other of said inner and outer surfaces comprises a plurality of convolute shapes;
a cavity defined by a said first sleeve, said cavity having an opening to access said cavity and a closure to allow opening and closing of said first sleeve;
said visco-elastic first sleeve being reversible to position said smooth surface outwardly in one configuration to provide a first feeling and said plurality of convolute shapes outwardly in a second configuration to provide a second feeling;
a plurality of visco-elastic chipped foam pieces disposed within said cavity.

14. A cushion, comprising:
a visco-elastic sleeve defined by a first layer of visco-elastic material and a second layer of visco-elastic material;
said first layer and said second layer being joined about a periphery to define a cavity;
chipped foam disposed within said cavity of said sleeve;
said first layer having an outer surface with a plurality of convolute shapes;
said second layer having a smooth outer surface.

15. The cushion of claim 14, said first layer and said second layer being the same thickness.

16. The cushion of claim 14, said first layer and said second layer being of differing thicknesses.

17. The cushion of claim 16, said second layer being a larger thickness dimension than said first layer.

18. The cushion of claim 14, said second layer having a smooth outer surface.
